(19) United States
(12) Patent Application Publication
(10) Pub. No.: US 2020/0019158 A1
(43) Pub. Date: Jan. 16, 2020

(54) APPARATUS AND METHOD FOR CONTROLLING MULTI-PURPOSE AUTONOMOUS VEHICLE

(71) Applicant: LG Electronics Inc., Seoul (KR)

(72) Inventors: Sung Suk KANG, Gyeonggi-do (KR); Eun Suk KIM, Incheon (KR); Eun Ju LEE, Seoul (KR)

(21) Appl. No.: 16/559,182

(22) Filed: Sep. 3, 2019

(30) Foreign Application Priority Data
Aug. 26, 2019 (KR) 10-2019-0104327

(51) Int. Cl. G05D 1/00; G08G 1/01; B60W 50/00

(52) U.S. Cl. CPC G05D 1/0027; G08G 1/0112; B60W 2050/0043; B60W 2550/402; B60W 2300/10; B60W 50/0098

(57) ABSTRACT

An embodiment of the present disclosure is, as a multi-purpose autonomous vehicle control apparatus for controlling an autonomous vehicle having a receiving space and an external display and for providing a shuttling operation for driving along a predetermined route, the multi-purpose autonomous vehicle control apparatus including a communicator for receiving a vehicle operation request signal, and a controller for generating a mode designation signal for designating a vehicle operation mode corresponding to the vehicle use purpose, and the communicator transmits the mode designation signal to the autonomous vehicle. At least one among an autonomous driving vehicle, a user terminal, and a server according to embodiments of the present disclosure may be associated or integrated with an artificial intelligence module, a drone (unmanned aerial vehicle (UAV)), a robot, an augmented reality (AR) device, a virtual reality (VR) device, a 5G service related device, and the like.

### CROSS-REFERENCE TO RELATED APPLICATION

This present application claims benefit of priority to Korean Patent Application No. 10-2019-0104327, entitled “APPARATUS AND METHOD FOR CONTROLLING MULTI-PURPOSE AUTONOMOUS VEHICLE,” filed on Aug. 26, 2019, in the Korean Intellectual Property Office, the entire disclosure of which is incorporated herein by reference.

### BACKGROUND

### 1. Technical Field

The present disclosure relates to an autonomous vehicle control apparatus and method, and more particularly, to a multi-purpose autonomous vehicle control apparatus and method for controlling an autonomous shuttle vehicle.

### 2. Description of Related Art

Recently, with the development of advanced technology and the development of the IT industry, interest in drones, electric vehicles, and artificial intelligence is gradually increasing, and additionally, many studies are being conducted on autonomous vehicles combined with IT and automotive technology.

In general, an autonomous vehicle means a vehicle that may autonomously drive to a set destination by recognizing surrounding objects such as a road, a vehicle, and a pedestrian even without a driver's operation.

Since the autonomous vehicle may be driven to an automatically set destination even without a driver's operation, it may be used as an autonomous shuttle during a weekday commute time in a business complex, a smart town, etc.

As one of the related arts related to the above-described autonomous shuttle vehicle, there is a passenger transportation shuttle that may operate automatically without a driver by guiding by itself by using an in-vehicle sensor and a steering wheel as disclosed in Korean Patent Laid-Open Publication No. 2018-0111887.

However, according to the conventional autonomous shuttle vehicle disclosed in the above-described Korean Patent Laid-Open Publication No. 2018-0111887, it drives only a predetermined route even in times when there are few passengers, and it is not possible to appropriately respond when it is used for other purposes or when an emergency situation occurring in times of low passenger demand.

For this reason, there is a problem in that it is not possible to appropriately utilize the autonomous vehicle and a window-type display device installed outside the vehicle even though the environment capable for using the vehicle as a multi-purpose is provided.

Accordingly, there is a need for an apparatus and a method capable of controlling an autonomous vehicle to be controlled to be used for other purposes in times when there are few passengers, or quickly responding to an emergency situation.

### SUMMARY OF THE DISCLOSURE

An aspect of the present disclosure is to provide a multi-purpose autonomous vehicle control apparatus and method, which may improve the method capable of controlling only the shuttle function for reciprocating only a predetermined route that has been the cause of the above-described problem, thereby appropriately responding to an occurrence of an emergency situation.

In addition, another aspect of the present disclosure is to provide a multi-purpose autonomous vehicle control apparatus and method, which may allow an autonomous vehicle to perform various functions such as delivery of goods and vehicle of eventin times of low passenger demand.

The present disclosure is not limited to the above-mentioned aspects, and other aspects, which are not mentioned, may be clearly understood by those skilled in the art from the description below.

A multi-purpose autonomous vehicle control apparatus according to an embodiment of the present disclosure may implement an apparatus capable of controlling the autonomous vehicle for use for other purposes in addition to the passenger transportation function in an emergency situation or a time when there are few passengers.

Specifically, a multi-purpose autonomous vehicle control apparatus according to an embodiment of the present disclosure may include, as the multi-purpose autonomous vehicle control apparatus for controlling an autonomous vehicle having a receiving space and an external display and for providing a shuttling operation for driving along a predetermined route, a communicator for receiving a vehicle operation request signal including a vehicle use time and a vehicle use purpose, and a controller for generating a mode designation signal for designating a vehicle operation mode corresponding to the vehicle use purpose, when the vehicle use purpose is a purpose allowable in the vehicle use time, and the communicator may transmit the mode designation signal to the autonomous vehicle, and the vehicle operation mode may include at least two modes.

In the multi-purpose autonomous vehicle control apparatus, according to an embodiment of the present disclosure, a controller may generate the mode designation signal when the vehicle use purpose is an emergency purpose for emergency patient transportation, and generate the mode designation signal except when the vehicle use time is a passenger transportation time, when the vehicle use purpose is not an emergency purpose, and the passenger transportation time is a time when the autonomous vehicle is in a shuttling operation or a call operation for passenger transportation.

An embodiment of the present disclosure may be the multi-purpose autonomous vehicle control apparatus in which the mode designation signal includes an emergency mode designation signal for designating a vehicle operation mode corresponding to an emergency purpose, a delivery mode designation signal for designating the vehicle operation mode corresponding to a goods delivery purpose, and an event mode designation signal for designating the vehicle operation mode corresponding to an event purpose.

An embodiment of the present disclosure may be the multi-purpose autonomous vehicle control apparatus in which the emergency mode designation signal includes emergency skin data for displaying an emergency vehicle skin on the external display and a control signal for moving the autonomous vehicle to a hospital as an emergency patient is received in the receiving space.

An embodiment of the present disclosure may be the multi-purpose autonomous vehicle control apparatus in which the delivery mode designation signal includes a control signal for moving the autonomous vehicle to a departure area and a destination and delivery information data for displaying delivery goods information on the external display as the delivery goods are received in the receiving space.

An embodiment of the present disclosure may be the multi-purpose autonomous vehicle control apparatus in which the controller generates the delivery mode designation signal as an empty space in which goods are received is present in the receiving space.

An embodiment of the present disclosure may be the multi-purpose autonomous vehicle control apparatus in which the event mode designation signal includes a control signal for receiving a passenger in the receiving space when satisfying a predetermined condition and event information data for displaying event information on the external display.

An embodiment of the present disclosure may be the multi-purpose autonomous vehicle control apparatus in which the communicator transmits the mode designation signal on the basis of the uplink grant of a 5G network connected to operate the autonomous vehicle in an autonomous mode.

An embodiment of the present disclosure may be a multi-purpose autonomous vehicle control method including, as the multi-purpose autonomous vehicle control method for controlling an autonomous vehicle having a receiving space and an external display and for providing a shuttling operation for driving along a predetermined route, receiving a vehicle operation request signal including a vehicle use time and a vehicle use purpose, generating a mode designation signal for designating a vehicle operation mode corresponding to a vehicle use purpose, when the vehicle use purpose is a purpose allowable in the vehicle use time, and transmitting the mode designation signal to the autonomous vehicle, and the vehicle operation mode includes at least two modes.

An embodiment of the present disclosure may be the multi-purpose autonomous vehicle control method in which generating the mode designation signal includes generating the mode designation signal, when the vehicle use purpose is an emergency purpose for an emergency patient transportation, and generating the mode designation signal except when the vehicle use time is a passenger transportation time, when the vehicle use purpose is not an emergency purpose, and the passenger transportation time is a time when the autonomous vehicle is in a shuttling operation or a call operation for passenger transportation.

An embodiment of the present disclosure may be the multi-purpose autonomous vehicle control method in which the mode designation signal includes an emergency mode designation signal for designating a vehicle operation mode corresponding to an emergency purpose, a delivery mode designation signal for designating the vehicle operation mode corresponding to a goods delivery purpose, and an event mode designation signal for designating the vehicle operation mode corresponding to an event purpose.

An embodiment of the present disclosure may be the multi-purpose autonomous vehicle control method in which the emergency mode designation signal includes emergency skin data for displaying an emergency vehicle skin on the external display and a control signal for moving the autonomous vehicle to a hospital as an emergency patient is received in the receiving space.

An embodiment of the present disclosure may be the multi-purpose autonomous vehicle control method in which the delivery mode designation signal includes a control signal for moving the autonomous vehicle to a departure area and a destination and delivery information data for displaying delivery goods information on the external display as the delivery goods are received in the receiving space.

An embodiment of the present disclosure may be the multi-purpose autonomous vehicle control method in which generating the mode designation signal includes generating the delivery mode designation signal as an empty space in which goods are received is present in the receiving space.

An embodiment of the present disclosure may be the multi-purpose autonomous vehicle control method in which the event mode designation signal includes a control signal for receiving a passenger in the receiving space when satisfying a predetermined condition and event information data for displaying event information on the external display.

An embodiment of the present disclosure may be the multi-purpose autonomous vehicle control method further including transmitting the mode designation signal on the basis of the uplink grant of a 5G network connected to operate the autonomous vehicle in an autonomous mode.

An embodiment of the present disclosure may be a computer readable recording medium recording a program including, as the computer readable recording medium recording a multi-purpose autonomous vehicle control program for controlling an autonomous vehicle having a receiving space and an external display, and for providing a shuttling operation for driving along a predetermined route, a means for receiving a vehicle operation request signal including a vehicle use time and a vehicle use purpose, a means for generating a mode designation signal for designating a vehicle operation mode corresponding to the vehicle use purpose, when the vehicle use purpose is a purpose allowable in the vehicle use time, and a means for transmitting the mode designation signal to the autonomous vehicle, and the vehicle operation mode includes at least two modes.

Details of other embodiments are included in the detailed description and drawings.

According to an embodiment of the present disclosure, it is possible to transfer a patient to the hospital according to a method for detecting whether the emergency situation occurs even while performing the passenger transportation function, displaying the emergency situation through the external display as the emergency situation has been detected, and performing the role of the emergency vehicle in the autonomous vehicle control.

According to an embodiment of the present disclosure, it is possible to perform various functions in connection with the previously owned receiving space and external display such as delivery of goods or events in times when the passenger demand is low and it is not necessary to perform the passenger transportation function.

Embodiments of the present disclosure are not limited to the embodiments described above, and other embodiments not mentioned above will be clearly understood from the description below.

### BRIEF DESCRIPTION OF THE DRAWINGS

FIG. 1 is a diagram showing a system to which a multi-purpose autonomous vehicle control apparatus according to an embodiment of the present disclosure is applied.

FIG. 2 is a block diagram showing the multi-purpose autonomous vehicle control apparatus installed at a server side according to an embodiment of the present disclosure.

FIG. 3 is a block diagram showing the multi-purpose autonomous vehicle control apparatus installed at a vehicle side according to an embodiment of the present disclosure.

FIG. 4 is a diagram showing an example of the basic operation of an autonomous vehicle and a 5G network in a 5G communication system.

FIG. 5 is a diagram showing an example of an applied operation of an autonomous vehicle and a 5G network in a 5G communication system.

FIGS. 6 to 9 are diagrams showing an example of the operation of an autonomous vehicle using 5G communication.

FIGS. 10 to 14 are operational flowcharts showing a multi-purpose autonomous vehicle control method according to an embodiment of the present disclosure.

FIG. 15 is a diagram showing a scheduling operation of the multi-purpose autonomous vehicle control apparatus installed at the vehicle side according to an embodiment of the present disclosure.

### DETAILED DESCRIPTION

Hereinafter, embodiments of the present disclosure will be described in detail with reference to the accompanying drawings. Like reference numerals refer to the like elements throughout and a duplicate description thereof is omitted. In the following description, the terms “module” and “unit” for referring to elements are assigned and used exchangeably in consideration of convenience of explanation, and thus, the terms per se do not necessarily have different meanings or functions. In the following description of the embodiments disclosed herein, the detailed description of related known technology will be omitted when it may obscure the subject matter of the embodiments according to the present disclosure. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

Although the terms first, second, third, and the like, may be used herein to describe various elements, components, regions, layers, and/or sections, these elements, components, regions, layers, and/or sections should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. The terms “connected” and “coupled” are not restricted to physical or mechanical connections or couplings, and may include electrical connections or couplings, whether direct or indirect. The connection may be such that the objects are permanently connected or releasably connected.

It must be noted that as used herein and in the appended claims, the singular forms “a,” “an,” and “the” include the plural references unless the context clearly dictates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

A vehicle described in this specification refers to a car, an automobile, and the like. Hereinafter, the vehicle will be exemplified as an automobile.

The vehicle described in the present specification may include, but is not limited to, a vehicle having an internal combustion engine as a power source, a hybrid vehicle having an engine and an electric motor as a power source, and an electric vehicle having an electric motor as a power source.

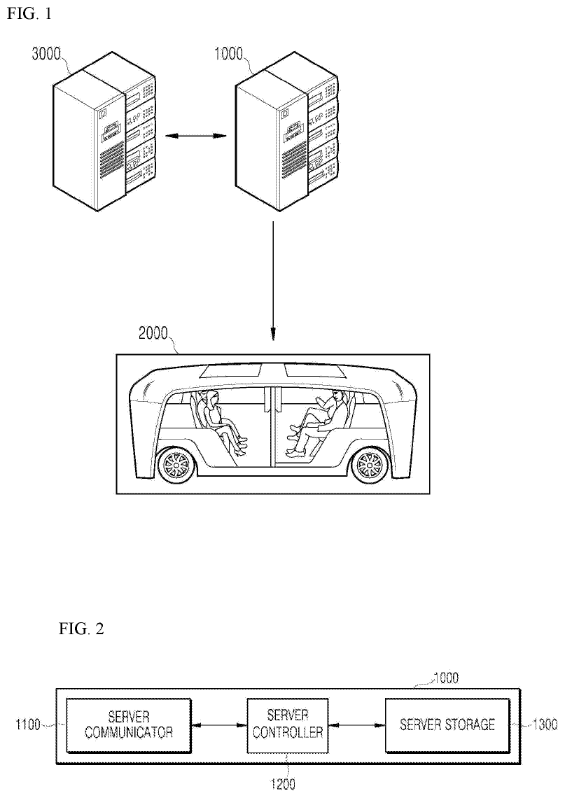

FIG. 1 is a diagram showing a system to which a multi-purpose autonomous vehicle control apparatus according to an embodiment of the present disclosure is applied.

Referring to FIG. 1, a server 1000 is a control system for controlling an autonomous vehicle 2000, and may provide to the autonomous vehicle 2000 data including text and images to be displayed on an external display of the autonomous vehicle 2000, for example, a local advertisement text, an event advertisement text, or emergency situation siren images.

The server 1000 may be a server operated by a vehicle manufacturer or a mobility service company, but is not limited thereto.

An external server 3000 may be connected with the server 1000 when the autonomous vehicle 2000 is used for non-passenger transportation purpose. At this time, the external server 3000 may be a library server, a medical institution server, etc.

FIG. 2 is a block diagram showing a multi-purpose autonomous vehicle control apparatus installed at a server side according to an embodiment of the present disclosure.

Referring to FIG. 2, the multi-purpose autonomous vehicle control apparatus may include a server communicator 1100, a server controller 1200, and a server storage 1300.

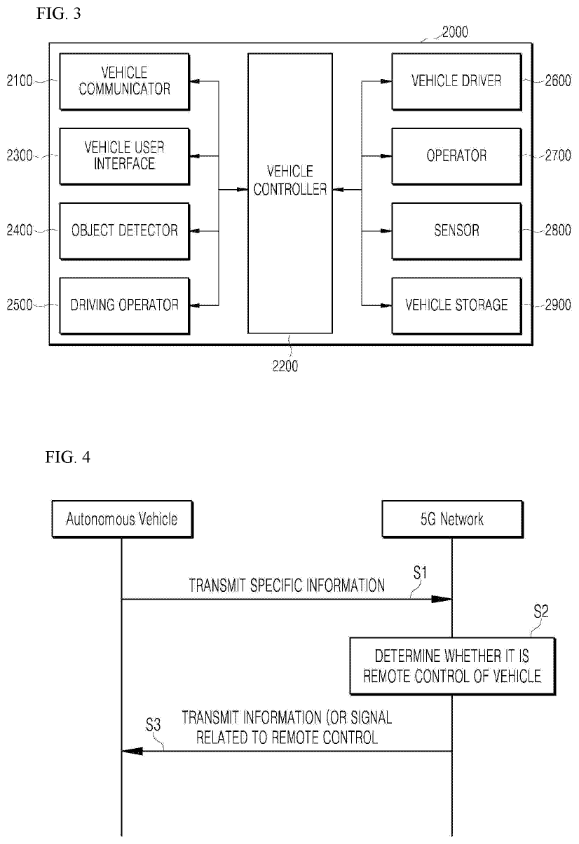

The server 1000 to which the multi-purpose autonomous vehicle control apparatus is applied according to an embodiment may include other components in addition to the components shown in FIG. 2 and described below, or may not include some of the components shown in FIG. 2 and described below. Meanwhile, although it has been shown in FIG. 3 assuming that the multi-purpose autonomous vehicle control apparatus has been mounted on the server 1000, the same apparatus may be applied to the vehicle 2000.

The server communicator 1100 may receive a vehicle operation request signal including a vehicle use time and a vehicle use purpose, and provide the received vehicle operation request signal to the server controller 1200.

The server communicator 1100 may transmit a mode designation signal to the autonomous vehicle 2000, and in particular, transmit the mode designation signal to the autonomous vehicle 2000 based on the uplink grant of a 5G network connected to operate the autonomous vehicle 2000 in an autonomous mode.

The server controller 1200 may generate the mode designation signal for designating a vehicle driving mode corresponding to the vehicle use purpose, and transmit the generated mode designation signal through the server communicator 1100, when the vehicle use purpose received through the server communicator 1100 is an allowable purpose at the vehicle use time specified by the vehicle operation request signal.

At this time, the vehicle driving mode may include at least two modes, and may include an emergency mode corresponding to an emergency purpose for emergency patient transportation, a delivery mode designating the vehicle driving mode corresponding to a goods delivery purpose, and an event mode that designates the vehicle driving mode corresponding to the event purpose.

That is, the mode designation signal may include an emergency mode designation signal that designates the vehicle driving mode corresponding to an emergency purpose, a delivery mode designation signal that designates the vehicle driving mode corresponding to a goods delivery purpose, and an event mode designation signal that designates the vehicle driving mode corresponding to an event purpose.

When the vehicle use purpose is an emergency purpose for emergency patient transportation, the server controller 1200 may immediately generate an emergency mode designation signal and then transmit it to the autonomous vehicle 2000 through the server communicator 1100, and when the vehicle use purpose is non-emergency purpose, the server controller 1200 may generate the mode designation signal and then transmit it to the autonomous vehicle 2000 through the server communicator 1100 except when the vehicle use time is a passenger transportation time.

That is, when the autonomous vehicle is in a shuttling operation or a call operation for passenger transportation, that is, when it is in a passenger transportation time, the server controller 1200 may control so that the autonomous vehicle 2000 is not used for purposes other than the use of the emergency purpose.

When the vehicle use purpose received through the server communicator 1100 is an emergency purpose for emergency patient transportation, the server controller 1200 may generate an emergency mode designation signal including emergency skin data for displaying an emergency vehicle skin on an external display of the autonomous vehicle 2000 and a control signal for moving the autonomous vehicle to a hospital as the emergency patient is received in a receiving space, and transmit the generated emergency mode designation signal to the autonomous vehicle 2000 through the server communicator 1100.

When the vehicle use purpose received through the server communicator 1100 is a delivery mode for delivery of goods, the server controller 1200 may generate the delivery mode designation signal including delivery information data for displaying delivery goods information on the external display of the autonomous vehicle 2000 and a control signal for moving the autonomous vehicle 2000 to a departure area, for example, home of a goods delivery requester, and a destination, for example, a library, and transmit the generated delivery mode designation signal to the autonomous vehicle 2000 through the server communicator 1100, as the delivery goods are received in the receiving space of the autonomous vehicle 2000.

At this time, the server controller 1200 may generate a delivery mode designation signal for the corresponding autonomous vehicle 2000 when there is an empty space in which the goods may be received in the receiving space of the autonomous vehicle 2000.

When receiving a vehicle operation request signal for designating delivery of goods, for example, a book delivery purpose, from the user terminal through the server communicator 1100, the server controller 1200 may confirm whether an empty space where the book is stored is present in the receiving space of the autonomous vehicle 2000, and generate the delivery mode designation signal for the corresponding autonomous vehicle 2000 by being permitted to use the receiving space as a book box when it is confirmed that the empty space is present.

When the vehicle use purpose received through the server communicator 1100 is an event purpose, the server controller 1200 may generate an event mode designation signal including event information data for displaying event information on the external display of the autonomous vehicle 2000 and a control signal for receiving a passenger within the receiving space of the autonomous vehicle 2000 when satisfying a predetermined condition, and transmit the generated event mode designation signal to the autonomous vehicle 2000 through the server communicator 1100.

The server storage 1300 may be various storage devices such as a ROM, a RAM, an EPROM, a flash drive, and a hard drive, in terms of hardware. The server storage 1300 may store various data for overall operation of the server 1000, such as a program for processing or controlling the server controller 1200, in particular user propensity information. The server storage 1300 may be integrally formed with the server controller 1200, or implemented as a sub-component of the server controller 1200.

FIG. 3 is a block diagram showing a multi-purpose autonomous vehicle control apparatus installed at a vehicle side according to an embodiment of the present disclosure.

Referring to FIG. 3, the multi-purpose autonomous vehicle control apparatus may include a vehicle communicator 2100, a vehicle controller 2200, a vehicle user interface 2300, an object detector 2400, a driving controller 2500, and a vehicle driver 2600, an operator 2700, a sensor 2800, and a vehicle storage 2900.

The vehicle 2000 to which the multi-purpose autonomous vehicle control apparatus is applied according to an embodiment may include other components in addition to the components shown in FIG. 3 and described below, or may not include some of the components shown in FIG. 3 and described below. For example, the vehicle 2000 may have a receiving space for receiving goods, in particular, a book, separately from the receiving space for receiving a passenger, and have a door in each receiving space that may be opened and closed outside the vehicle 2000.

The vehicle 2000 may be switched from an autonomous mode to a manual mode, or switched from the manual mode to the autonomous mode depending on the driving situation. Here, the driving situation may be determined by at least one of information received by the vehicle communicator 2100, external object information detected by the object detector 2400, and navigation information obtained by a navigation module.

The vehicle 2000 may be switched from the autonomous mode to the manual mode, or from the manual mode to the autonomous mode, according to a user input received through the user interface 2300.

When the vehicle 2000 is operated in the autonomous mode, the vehicle 2000 may be operated under the control of the operator 2700 that controls driving, parking, and unparking. When the vehicle 2000 is operated in the manual mode, the vehicle 2000 may be operated by an input of the driver's mechanical driving operation.

The vehicle communicator 2100 may be a module for performing communication with an external device. Here, the external device may be a user terminal and servers 1000, 3000.

The vehicle communicator 2100 may receive a mode designation signal from the server 1000, and provide the received mode designation signal to the vehicle controller 2200.

The vehicle communicator 2100 may receive a vehicle operation request signal from the vehicle controller 2200, and transmit the input vehicle operation request signal to the server 1000.

At this time, the user terminal may directly transmit the vehicle operation request signal including the vehicle use time and the vehicle use purpose designated by the user to the server 1000.

The vehicle communicator 2100 may include at least one among a transmission antenna, a reception antenna, a radio frequency (RF) circuit capable of implementing various communication protocols, and an RF element in order to perform communication.

The vehicle communicator 2100 may perform short range communication, GPS signal reception, V2X communication, optical communication, broadcast transmission/reception, and intelligent transport systems (ITS) communication functions.

The vehicle communicator 2100 may further support other functions than the functions described, or may not support some of the functions described, depending on the embodiment.

The vehicle communicator 2100 may support short-range communication by using at least one among Bluetooth™, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, and Wireless Universal Serial Bus (Wireless USB) technologies.

The vehicle communicator 2100 may form short-range wireless communication networks so as to perform short-range communication between the vehicle 2000 and at least one external device.

The vehicle communicator 2100 may include a Global Positioning System (GPS) module or a Differential Global Positioning System (DGPS) module for obtaining location information of the vehicle 2000.

The vehicle communicator 2100 may include a module for supporting wireless communication between the vehicle 2000 and a server (V2I: vehicle to infrastructure), communication with another vehicle (V2V: vehicle to vehicle) or communication with a pedestrian (V2P: vehicle to pedestrian). That is, the vehicle communicator 1100 may include a V2X communication module. The V2X communication module may include an RF circuit capable of implementing V2I, V2V, and V2P communication protocols.

The vehicle communicator 2100 may receive a danger information broadcast signal transmitted by another vehicle through the V2X communication module, and may transmit a danger information inquiry signal and receive a danger information response signal in response thereto.

The vehicle communicator 2100 may include an optical communication module for performing communication with an external device via light. The optical communication module may include a light transmitting module for converting an electrical signal into an optical signal and transmitting the optical signal to the outside, and a light receiving module for converting the received optical signal into an electrical signal.

The light transmitting module may be formed to be integrated with the lamp included in the vehicle 2000.

The vehicle communicator 2100 may include a broadcast communication module for receiving broadcast signals from an external broadcast management server, or transmitting broadcast signals to the broadcast management server through broadcast channels. The broadcast channel may include a satellite channel and a terrestrial channel. Examples of the broadcast signal may include a TV broadcast signal, a radio broadcast signal, and a data broadcast signal.

The vehicle communicator 2100 may include an ITS communication module that exchanges information, data or signals with a traffic system. The ITS communication module may provide the obtained information and data to the traffic system. The ITS communication module may receive information, data, or signals from the traffic system. For example, the ITS communication module may receive road traffic information from the communication system and provide the road traffic information to the vehicle controller 2200. For example, the ITS communication module may receive control signals from the traffic system and provide the control signals to the vehicle controller 2200 or a processor provided in the vehicle 2000.

Depending on the embodiment, the overall operation of each module of the vehicle communicator 2100 may be controlled by a separate process provided in the vehicle communicator 2100. The vehicle communicator 2100 may include a plurality of processors, or may not include a processor. When a processor is not included in the vehicle communicator 2100, the vehicle communicator 2100 may be operated by either a processor of another apparatus in the vehicle 2000 or the vehicle controller 2200.

The vehicle communicator 2100 may, together with the vehicle user interface 2300, implement a vehicle-use display device. In this case, the vehicle-use display device may be referred to as a telematics device or an audio video navigation (AVN) device.

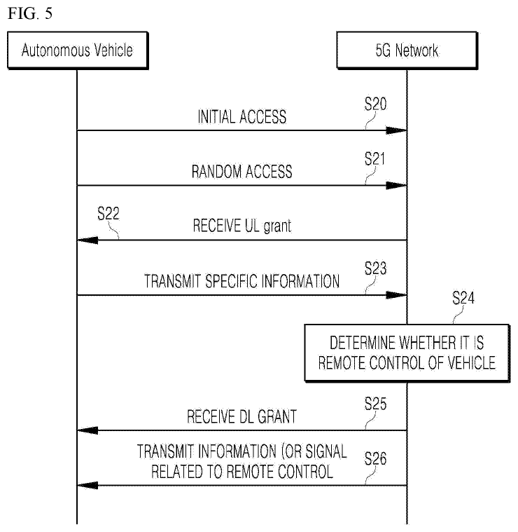

FIG. 4 is a diagram showing an example of the basic operation of an autonomous vehicle and a 5G network in a 5G communication system.

The vehicle communicator 2100 may transmit specific information over a 5G network when the vehicle 2000 is operated in the autonomous mode.

The specific information may include autonomous driving related information.

The autonomous driving related information may be information directly related to the driving control of the vehicle. For example, the autonomous driving related information may include at least one among object data indicating an object near the vehicle, map data, vehicle status data, vehicle location data, and driving plan data.

The autonomous driving related information may further include service information necessary for autonomous driving. For example, the specific information may include information on a destination inputted through the user terminal 2300 and a safety rating of the vehicle.

In addition, the 5G network may determine whether a vehicle is to be remotely controlled (S2).

The 5G network may include a server or a module for performing remote control related to autonomous driving.

The 5G network may transmit information (or a signal) related to the remote control to an autonomous driving vehicle (S3).

As described above, information related to the remote control may be a signal directly applied to the autonomous driving vehicle, and may further include service information necessary for autonomous driving. The autonomous driving vehicle according to this embodiment may receive service information such as insurance for each interval selected on a driving route and risk interval information, through a server connected to the 5G network to provide services related to the autonomous driving.

An essential process for performing 5G communication between the autonomous vehicle 2000 and the 5G network (for example, an initial access process between the vehicle 2000 and the 5G network) will be briefly described with reference to FIG. 5 to FIG. 9 below.

An example of application operations through the autonomous vehicle 2000 performed in the 5G communication system and the 5G network is as follows.

The vehicle 2000 may perform an initial access process with the 5G network (initial access step, S20). In this case, the initial access procedure includes a cell search process for acquiring downlink (DL) synchronization and a process for acquiring system information.

The vehicle 2000 may perform a random access process with the 5G network (random access step, S21). At this time, the random access procedure includes an uplink (UL) synchronization acquisition process or a preamble transmission process for UL data transmission, a random access response reception process, and the like.

The 5G network may transmit an Uplink (UL) grant for scheduling transmission of specific information to the autonomous vehicle 2000 (UL grant receiving step, S22).

The procedure by which the vehicle 2000 receives the UL grant includes a scheduling process in which a time/frequency resource is allocated for transmission of UL data to the 5G network.

The autonomous vehicle 2000 may transmit specific information over the 5G network based on the UL grant (specific information transmission step, S23).

The 5G network may determine whether the vehicle 2000 is to be remotely controlled based on the specific information transmitted from the vehicle 2000 (vehicle remote control determination step, S24).

The autonomous vehicle 2000 may receive the DL grant through a physical DL control channel for receiving a response on pre-transmitted specific information from the 5G network (DL grant receiving step, S25).

The 5G network may transmit information (or a signal) related to the remote control to the autonomous vehicle 2000 based on the DL grant (remote control related information transmission step, S26).

A process in which the initial access process and/or the random access process between the 5G network and the autonomous vehicle 2000 is combined with the DL grant receiving process has been exemplified. However, the present disclosure is not limited thereto.

For example, an initial access procedure and/or a random access procedure may be performed through an initial access step, an UL grant reception step, a specific information transmission step, a remote control decision step of the vehicle, and an information transmission step associated with remote control. In addition, for example, the initial access process and/or the random access process may be performed through the random access step, the UL grant receiving step, the specific information transmission step, the vehicle remote control determination step, and the remote control related information transmission step. The autonomous vehicle 2000 may be controlled by the combination of an AI operation and the DL grant receiving process through the specific information transmission step, the vehicle remote control determination step, the DL grant receiving step, and the remote control related information transmission step.

The operation of the autonomous vehicle 2000 described above is merely exemplary, but the present disclosure is not limited thereto.

For example, the operation of the autonomous vehicle 2000 may be performed by selectively combining the initial access step, the random access step, the UL grant receiving step, or the DL grant receiving step with the specific information transmission step, or the remote control related information transmission step. The operation of the autonomous vehicle 2000 may include the random access step, the UL grant receiving step, the specific information transmission step, and the remote control related information transmission step. The operation of the autonomous vehicle 2000 may include the initial access step, the random access step, the specific information transmission step, and the remote control related information transmission step. The operation of the autonomous vehicle 2000 may include the UL grant receiving step, the specific information transmission step, the DL grant receiving step, and the remote control related information transmission step.

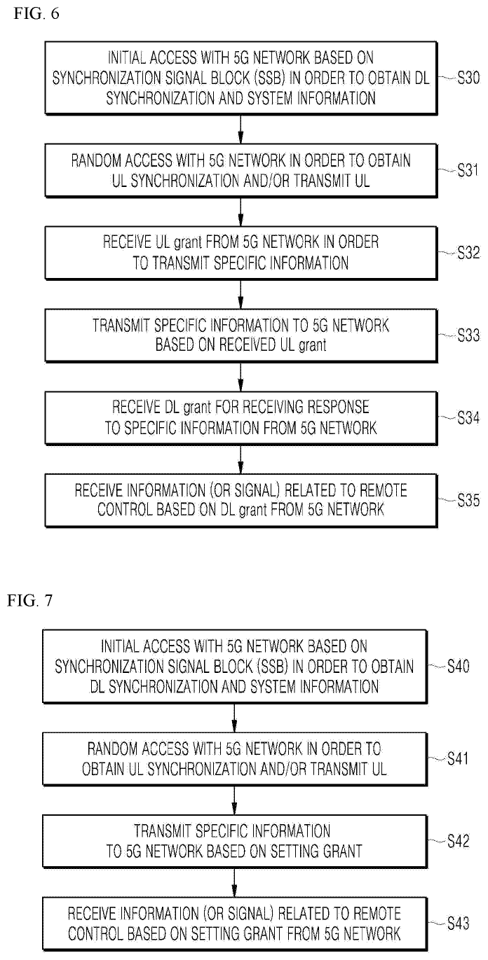

As shown in FIG. 6, the vehicle 2000 including an autonomous driving module may perform an initial access process with the 5G network based on Synchronization Signal Block (SSB) in order to acquire DL synchronization and system information (initial access step).

The autonomous vehicle 2000 may perform a random access process with the 5G network for UL synchronization acquisition and/or UL transmission (random access step, S31).

The autonomous vehicle 2000 may receive the UL grant from the 5G network for transmitting specific information (UL grant receiving step, S32).

The autonomous vehicle 2000 may transmit the specific information to the 5G network based on the UL grant (specific information transmission step, S33).

The autonomous vehicle 2000 may receive the DL grant from the 5G network for receiving a response to the specific information (DL grant receiving step, S34).

The autonomous vehicle 2000 may receive remote control related information (or a signal) from the 5G network based on the DL grant (remote control related information receiving step, S35).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. Further, a QCL relationship may be added to the DL grant reception step with respect to the beam receiving direction of the PDCCH including the DL grant.

As shown in FIG. 7, the autonomous vehicle 2000 may perform an initial access process with the 5G network based on SSB for acquiring DL synchronization and system information (initial access step, S40).

The autonomous vehicle 2000 may perform a random access process with the 5G network for UL synchronization acquisition and/or UL transmission (random access step, S41).

The autonomous vehicle 2000 may transmit specific information based on a configured grant to the 5G network (UL grant receiving step, S42). In other words, instead of receiving the UL grant from the 5G network, the configured grant may be received.

The autonomous vehicle 2000 may receive remote control related information (or a signal) from the 5G network based on the setting grant (remote control related information receiving step, S43).

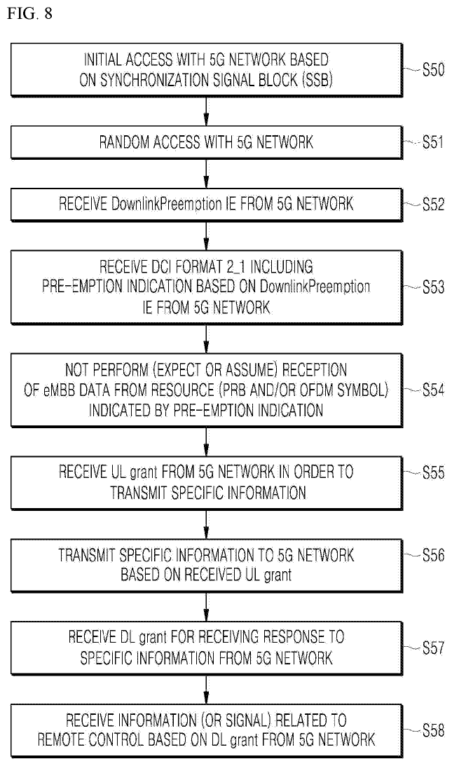

As shown in FIG. 8, the autonomous vehicle 2000 may perform an initial access process with the 5G network based on SSB for acquiring DL synchronization and system information (initial access step, S50).

The autonomous vehicle 2000 may perform a random access process with the 5G network for UL synchronization acquisition and/or UL transmission (random access step, S51).

In addition, the autonomous vehicle 2000 may receive Downlink Preemption (DL) and Information Element (IE) from the 5G network (DL Preemption IE reception step, S52).

The autonomous vehicle 2000 may receive DCI (Downlink Control Information) format 2_1 including preemption indication based on the DL preemption IE from the 5G network (DCI format 2_1 receiving step, S53).

The autonomous vehicle 2000 may not perform (or expect or assume) the reception of eMBB data in the resource (PRB and/or OFDM symbol) indicated by the pre-emption indication (step of not receiving eMBB data, S54).

The autonomous vehicle 2000 may receive the UL grant over the 5G network for transmitting specific information (UL grant receiving step, S55).

The autonomous vehicle 2000 may transmit the specific information to the 5G network based on the UL grant (specific information transmission step, S56).

The autonomous vehicle 2000 may receive the DL grant from the 5G network for receiving a response to the specific information (DL grant receiving step, S57).

The autonomous vehicle 2000 may receive the remote control related information (or signal) from the 5G network based on the DL grant (remote control related information receiving step, S58).

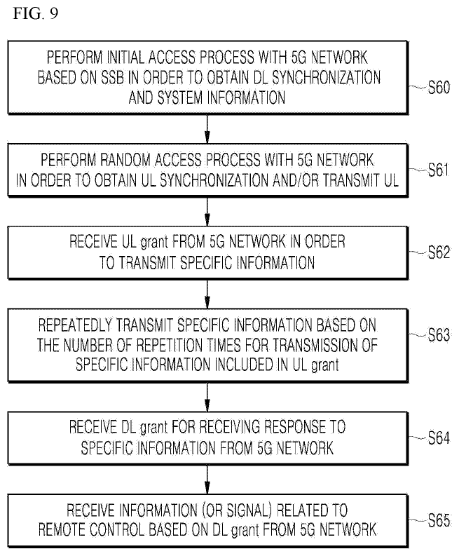

As shown in FIG. 9, the autonomous vehicle 2000 may perform an initial access process with the 5G network based on SSB for acquiring DL synchronization and system information (initial access step, S60).

The autonomous vehicle 2000 may perform a random access process with the 5G network for UL synchronization acquisition and/or UL transmission (random access step, S61).

The autonomous vehicle 2000 may receive the UL grant over the 5G network for transmitting specific information (UL grant receiving step, S62).

When specific information is transmitted repeatedly, the UL grant may include information on the number of repetitions, and the specific information may be repeatedly transmitted based on information on the number of repetitions (specific information repetition transmission step, S63).

The autonomous vehicle 2000 may transmit the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of Resource Block (6RB) and Resource Block (1RB).

The autonomous vehicle 2000 may receive the DL grant from the 5G network for receiving a response to the specific information (DL grant receiving step, S64).

The autonomous vehicle 2000 may receive the remote control related information (or signal) from the 5G network based on the DL grant (remote control related information receiving step, S65).

The above-described 5G communication technique may be applied in combination with the embodiment proposed in this specification, which will be described in FIG. 1 to FIG. 13F, or supplemented to specify or clarify the technical feature of the embodiment proposed in this specification.

The vehicle 2000 may be connected to an external server through a communication network, and may be capable of moving along a predetermined route without a driver's intervention by using an autonomous driving technique.

In the following embodiments, the user may be interpreted as a driver, a passenger, or the owner of a user terminal.

While the vehicle 2000 is driving in the autonomous mode, the type and frequency of accident occurrence may depend on the capability of the vehicle 1000 of sensing dangerous elements in the vicinity in real time. The route to the destination may include sectors having different levels of risk due to various causes such as weather, terrain characteristics, traffic congestion, and the like.

At least one among an autonomous driving vehicle, a user terminal, and a server according to embodiments of the present disclosure may be associated or integrated with an artificial intelligence module, a drone (unmanned aerial vehicle (UAV)), a robot, an augmented reality (AR) device, a virtual reality (VR) device, a 5G service related device, and the like.

For example, the vehicle 2000 may operate in association with at least one artificial intelligence module or robot included in the vehicle 2000 in the autonomous mode.

For example, the vehicle 2000 may interact with at least one robot. The robot may be an autonomous mobile robot (AMR) capable of driving by itself. Being capable of driving by itself, the AMR may freely move, and may include a plurality of sensors so as to avoid obstacles during traveling. The AMR may be a flying robot (such as a drone) equipped with a flight device. The AMR may be a wheel-type robot equipped with at least one wheel, and which is moved through the rotation of the at least one wheel. The AMR may be a leg-type robot equipped with at least one leg, and which is moved using the at least one leg.

The robot may function as a device that enhances the convenience of a user of a vehicle. For example, the robot may move a load placed in the vehicle 2000 to a final destination. For example, the robot may perform a function of providing route guidance to a final destination to a user who alights from the vehicle 2000. For example, the robot may perform a function of transporting the user who alights from the vehicle 2000 to the final destination

At least one electronic apparatus included in the vehicle 2000 may communicate with the robot through a communication device.

At least one electronic apparatus included in the vehicle 2000 may provide, to the robot, data processed by the at least one electronic apparatus included in the vehicle 1000. For example, at least one electronic apparatus included in the vehicle 2000 may provide, to the robot, at least one among object data indicating an object near the vehicle, HD map data, vehicle status data, vehicle position data, and driving plan data.

At least one electronic apparatus included in the vehicle 2000 may receive, from the robot, data processed by the robot. At least one electronic apparatus included in the vehicle 2000 may receive at least one among sensing data sensed by the robot, object data, robot status data, robot location data, and robot movement plan data.

At least one electronic apparatus included in the vehicle 2000 may generate a control signal on the basis of data received from the robot. For example, at least one electronic apparatus included in the vehicle may compare information on the object generated by an object detection device with information on the object generated by the robot, and generate a control signal on the basis of the comparison result. At least one electronic device included in the vehicle 2000 may generate a control signal so as to prevent interference between the route of the vehicle and the route of the robot.

At least one electronic apparatus included in the vehicle 2000 may include a software module or a hardware module for implementing an artificial intelligence (AI) (hereinafter referred to as an artificial intelligence module). At least one electronic device included in the vehicle may input the acquired data to the AI module, and use the data which is outputted from the AI module.

The artificial intelligence module may perform machine learning of input data by using at least one artificial neural network (ANN). The artificial intelligence module may output driving plan data through machine learning of input data.

At least one electronic apparatus included in the vehicle 2000 may generate a control signal on the basis of the data outputted from the artificial intelligence module.

According to the embodiment, at least one electronic apparatus included in the vehicle 2000 may receive data processed by an artificial intelligence from an external device through a communication device. At least one electronic apparatus included in the vehicle may generate a control signal on the basis of the data processed by the artificial intelligence.

The vehicle controller 2200 may receive the control signal of the server 1000 through the vehicle communicator 2100, and control the autonomous mode operation according to the control signal.

The vehicle controller 2200 may receive the mode designation signal through the vehicle communicator 2100, determine the use purpose of the autonomous vehicle 2000 according to the received mode designation signal, and control the autonomous vehicle 2000 according to the determined use purpose.

Before receiving the mode designation signal for designating a goods delivery purpose, the vehicle controller 2200 may confirm whether the empty space in which the goods are received is present in the receiving space for goods installed in the autonomous vehicle 2000, according to the request of the server 1000.

When receiving the mode designation signal for designating the goods delivery purpose, the vehicle controller 2200 may display the delivery goods information included in the mode designation signal, for example, a QR code, on an external display, which is one module of the vehicle user interface 2300, in particular, a display installed outside the receiving space.

When receiving goods recipient information, for example, recipient fingerprint information as the delivery goods information, the vehicle controller 2200 may control to open the door of the receiving space only when the user identification information provided by the goods recipient and the goods recipient information coincide with each other after reaching the goods delivery destination.

When an emergency purpose occurs in the autonomous vehicle 2000 through the vehicle user interface 2300, the vehicle controller 2200 may generate a vehicle operation request signal for designating an emergency purpose, and transmit the generated vehicle operation request signal to the server 1000 through the vehicle communicator 2100.

When receiving the mode designation signal for designating an emergency purpose, the vehicle controller 2200 may control to display it on the external display, which is one module of the vehicle user interface 2300, by processing the emergency skin data included in the mode designation signal.

When receiving the mode designation signal for designating an event purpose, the vehicle controller 2200 may control to display it on the external display, which is one module of the vehicle user interface 2300, by processing the event information included in the mode designation signal.

When the event mode designation signal includes a passenger receiving condition, the vehicle controller 2200 may permit boarding in the autonomous vehicle 2000 only when the user identification information of the passenger who intends to board in the autonomous vehicle 2000 and the passenger information according to the passenger receiving condition coincide with each other.

The vehicle controller 2200 may be implemented using at least one among application specific integrated circuits (ASICs), digital signal processors (DSPs), digital signal processing devices (DSPDs), programmable logic devices (PLDs), field [programmable gate arrays (FPGAs), processors, controllers, micro-controllers, microprocessors, and other electronic units for performing other functions.

The vehicle user interface 2300 may allow interaction between the vehicle 2000 and a vehicle user, receive an input signal of the user, transmit the received input signal to the vehicle controller 2200, and provide information included in the vehicle 2000 to the user under the control of the vehicle controller 2200. The vehicle user interface 2300 may include, but is not limited to, an input module, an internal camera, a bio-sensing module, and an output module.

The input module is for receiving information from a user.

The data collected by the input module may be analyzed by the vehicle controller 2200 and processed by the user's control command.

The input module may receive the destination of the vehicle 2000 from the user and provide the destination to the controller 2200.

The input module may input to the vehicle controller 2200 a signal for designating and deactivating at least one of the plurality of sensor modules of the object detector 2400 according to the user's input.

The input module may be located inside the vehicle. For example, the input module may be located on one area of a steering wheel, one area of an instrument panel, one area of a seat, one area of each pillar, one area of a door, one area of a center console, one area of a head lining, one area of a sun visor, one area of a windshield, or one area of a window.

When the emergency purpose occurs in the autonomous vehicle 2000, an internal camera may obtain an information image indicating the occurrence of an emergency situation, and provide the obtained image to the vehicle controller 2200.

The output module is for generating an output related to visual, auditory, or tactile information. The output module may output a sound or an image.

The output module may include at least one of a display module, an acoustic output module, and a haptic output module.

The display module may display graphic objects corresponding to various information.

The display module may including at least one of a liquid crystal display (LCD), a thin film transistor liquid crystal display (TFT LCD), an organic light emitting diode (OLED), a flexible display, a 3D display, or an e-ink display, and may be installed outside the vehicle, in particular, outside the door of the receiving space.

The display module may have a mutual layer structure with a touch input module, or may be integrally formed to implement a touch screen.

The display module may be implemented as a head up display (HUD). When the display module is implemented as an HUD, the display module may include a projection module to output information through an image projected onto a windshield or a window.

The display module may include a transparent display. The transparent display may be attached to the windshield or the window.

The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted.

The vehicle user interface 2300 may include a plurality of display modules.

The display module may be located on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The sound output module may convert an electrical signal provided from the vehicle controller 2200 into an audio signal. The sound output module may include at least one speaker.

The haptic output module may generate a tactile output. For example, the haptic output module may operate to allow the user to perceive the output by vibrating a steering wheel, a seat belt, and a seat.

The object detector 2400 is for detecting an object located outside the vehicle 2000. The object detector 2400 may generate object information based on the sensing data, and transmit the generated object information to the vehicle controller 2200. Examples of the object may include various objects related to the driving of the vehicle 2000, such as a lane, another vehicle, a pedestrian, a motorcycle, a traffic signal, light, a road, a structure, a speed bump, a landmark, and an animal.

The object detector 2400 may include a camera module, Light Imaging Detection and Ranging (LIDAR), an ultrasonic sensor, a Radio Detection and Ranging (RADAR) 1450, and an infrared sensor as a plurality of sensor modules.

The object detector 2400 may sense environmental information around the vehicle 2000 through a plurality of sensor modules.

Depending on the embodiment, the object detector 2400 may further include components other than the components described, or may not include some of the components described.

The radar may include an electromagnetic wave transmitting module and an electromagnetic wave receiving module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method.

The radar may detect an object based on a time-of-flight (TOF) method or a phase-shift method using an electromagnetic wave as a medium, and detect the location of the detected object, the distance to the detected object, and the relative speed of the detected object.

The radar may be located at an appropriate position outside the vehicle for sensing an object located at the front, back, or side of the vehicle.

The lidar may include a laser transmitting module, and a laser receiving module. The lidar may be embodied using the time of flight (TOF) method or in the phase-shift method.

The lidar may be implemented using a driving method or a non-driving method.

When the lidar is embodied in the driving method, the lidar may rotate by means of a motor, and detect an object near the vehicle 2000. When the lidar is implemented in the non-driving method, the lidar may detect an object within a predetermined range with respect to the vehicle 2000 by means of light steering. The vehicle 2000 may include a plurality of non-driven type lidars.

The lidar may detect an object using the time of flight (TOF) method or the phase-shift method using laser light as a medium, and detect the location of the detected object, the distance from the detected object and the relative speed of the detected object.

The lidar may be located at an appropriate position outside the vehicle for sensing an object located at the front, back, or side of the vehicle.

The imaging unit may be located at a suitable place outside the vehicle, for example, the front, rear, right side mirror, and left side mirror of the vehicle, in order to obtain the vehicle exterior image. The imaging unit may be a mono camera, but is not limited thereto, and may be a stereo camera, an Around View Monitoring (AVM) camera, or a 360 degree camera.

The imaging unit may be located close to the front windshield in the interior of the vehicle in order to obtain an image of the front of the vehicle. Alternatively, the imaging unit may be located around a front bumper or a radiator grille.

The imaging unit may be located close to the rear glass in the interior of the vehicle in order to obtain an image of the rear of the vehicle. Alternatively, the imaging unit may be located around a rear bumper, a trunk, or a tail gate.

The imaging unit may be located close to at least one of the side windows in the interior of the vehicle in order to obtain an image of the vehicle side. In addition, the imaging unit may be located around a fender or a door.

The imaging unit may provide the obtained image for passenger identification to the vehicle controller 2200.

The ultrasonic sensor may include an ultrasonic transmitting module, and an ultrasonic receiving module. The ultrasonic sensor may detect an object based on ultrasonic waves, and detect the location of the detected object, the distance from the detected object, and the relative speed of the detected object.

The ultrasonic sensor may be located at an appropriate position outside the vehicle for sensing an object at the front, back, or side of the vehicle.

The infrared sensor may include an infrared transmitting module, and an infrared receiving module. The infrared sensor may detect an object based on infrared light, and detect the location of the detected object, the distance from the detected object, and the relative speed of the detected object.

The infrared sensor may be located at an appropriate position outside the vehicle for sensing an object at the front, back, or side of the vehicle.

The vehicle controller 2200 may control the overall operation of the object detector 2400.

The vehicle controller 2200 may compare data sensed by the radar, the lidar, the ultrasonic sensor, and the infrared sensor with pre-stored data so as to detect or classify an object.

The vehicle controller 2200 may detect an object and perform tracking of the object based on the obtained image. The vehicle controller 2200 may perform operations such as calculation of the distance from an object and calculation of the relative speed of the object through image processing algorithms.

For example, the vehicle controller 2200 may obtain the distance information from the object and the relative speed information of the object from the obtained image based on the change of size of the object over time.

For example, the vehicle controller 2200 may obtain the distance information from the object and the relative speed information of the object through, for example, a pin hole model and road surface profiling.

The vehicle controller 2200 may detect an object and perform tracking of the object based on the reflected electromagnetic wave reflected back from the object. The vehicle controller 2200 may perform operations such as calculation of the distance to the object and calculation of the relative speed of the object based on the electromagnetic waves.

The vehicle controller 2200 may detect an object, and perform tracking of the object based on the reflected laser light reflected back from the object. Based on the laser light, the vehicle controller 2200 may perform operations such as calculation of the distance to the object and calculation of the relative speed of the object based on the laser light.

The vehicle controller 2200 may detect an object and perform tracking of the object based on the reflected ultrasonic wave reflected back from the object. The vehicle controller 2200 may perform operations such as calculation of the distance to the object and calculation of the relative speed of the object based on the reflected ultrasonic wave.

The vehicle controller 2200 may detect an object and perform tracking of the object based on the reflected infrared light reflected back from the object. The vehicle controller 2200 may perform operations such as calculation of the distance to the object and calculation of the relative speed of the object based on the infrared light.

Depending on the embodiment, the object detector 2400 may include a separate processor from the vehicle processor 2200. In addition, the radar, the lidar, the ultrasonic sensor, and the infrared sensor may each include a processor.

When a processor is included in the object detector 2400, the object detector 2400 may be operated under the control of the processor controlled by the vehicle controller 2200.

The driving controller 2500 may receive a user input for driving. In the manual mode, the vehicle 2000 may be driven based on a signal provided by the driving controller 2500.

The vehicle driver 2600 may electrically control the driving of various apparatuses in the vehicle 2000. The vehicle driver 2600 may electrically control the driving of a power train, a chassis, a door/window, a safety device, a lamp, and an air conditioner in the vehicle 2000.

The operator 2700 may control various operations of the vehicle 2000. The operator 2700 may operate in the autonomous mode.

The operator 2700 may include a driving module, an unparking module, and a parking module.

Depending on the embodiment, the operator 2700 may further include constituent elements other than the constituent elements to be described, or may not include some of the constitute elements.

The operator 2700 may include a processor under the control of the vehicle controller 2200. Each module of the operator 2700 may include a processor individually.

Depending on the embodiment, when the operator 2700 is implemented as software, it may be a sub-concept of the vehicle controller 2200.

The driving module may perform driving of the vehicle 2000.

The driving module may receive object information from the object detector 2400, and provide a control signal to a vehicle driving module to perform the driving of the vehicle 2000.

The driving module may receive a signal from an external device through the vehicle communicator 2100, and provide a control signal to the vehicle driving module, so that the driving of the vehicle 2000 may be performed.

In the unparking module, unparking of the vehicle 2000 may be performed.

The unparking module may receive navigation information from the navigation module, and provide a control signal to the vehicle driving module to perform the departure of the vehicle 2000.

In the unparking module, object information may be received from the object detector 2400, and a control signal may be provided to the vehicle driving module, so that the unparking of the vehicle 2000 may be performed.

In the unparking module, a signal may be provided from an external device through the vehicle communicator 2100, and a control signal may be provided to the vehicle driving module, so that the unparking of the vehicle 2000 may be performed.

In the parking module, parking of the vehicle 2000 may be performed.

The parking module may receive navigation information from the navigation module, and provide a control signal to the vehicle driving module to perform the parking of the vehicle 2000.

In the parking module, object information may be provided from the object detector 2400, and a control signal may be provided to the vehicle driving module, so that the parking of the vehicle 2000 may be performed.

In the parking module, a signal may be provided from the external device through the vehicle communicator 2100, and a control signal may be provided to the vehicle driving module so that the parking of the vehicle 2000 may be performed.

The navigation module may provide the navigation information to the vehicle controller 2200. The navigation information may include at least one of map information, set destination information, route information according to destination setting, information about various objects on the route, lane information, or current location information of the vehicle.

The navigation module may provide the vehicle controller 2200 with a parking lot map of the parking lot entered by the vehicle 2000. When the vehicle 2000 enters the parking lot, the vehicle controller 2200 receives the parking lot map from the navigation module, and projects the calculated route and fixed identification information on the provided parking lot map so as to generate the map data.

The navigation module may include a memory. The memory may store navigation information. The navigation information may be updated by information received through the vehicle communicator 2100. The navigation module may be controlled by an internal processor, or may operate by receiving an external signal, for example, a control signal from the vehicle controller 2200, but the present disclosure is not limited thereto.

The driving module of the operator 2700 may be provided with the navigation information from the navigation module, and may provide a control signal to the vehicle driving module so that driving of the vehicle 2000 may be performed.

The sensor 2800 may sense the state of the vehicle 2000 using a sensor mounted on the vehicle 2000, that is, a signal related to the state of the vehicle 2000, and obtain movement route information of the vehicle 2000 according to the sensed signal. The sensor 2800 may provide the obtained movement route information to the vehicle controller 2200.

The sensor 2800 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto.

The sensor 2800 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 2800 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), but is not limited thereto.

The sensor 2800 may generate vehicle status information based on sensing data. The vehicle state information may be information generated based on data sensed by various sensors included in the inside of the vehicle.

The vehicle status information may include at least one among posture information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, vehicle interior temperature information, vehicle interior humidity information, pedal position information, and vehicle engine temperature information.

The vehicle storage 2900 may be electrically connected to the vehicle controller 2200. The vehicle storage 2900 may store basic data for each unit of the multi-purpose autonomous vehicle control apparatus, control data for operation control of each unit of the multi-purpose autonomous vehicle control apparatus, and input/output data. The vehicle storage 2900 may be various storage devices such as a ROM, a RAM, an EPROM, a flash drive, and a hard drive, in terms of hardware. The vehicle storage 2900 may store various data for overall operation of the vehicle 2000, such as a program for processing or controlling the vehicle controller 2200, in particular driver propensity information. The vehicle storage 2900 may be integrally formed with the vehicle controller 2200, or implemented as a sub-component of the vehicle controller 2200.

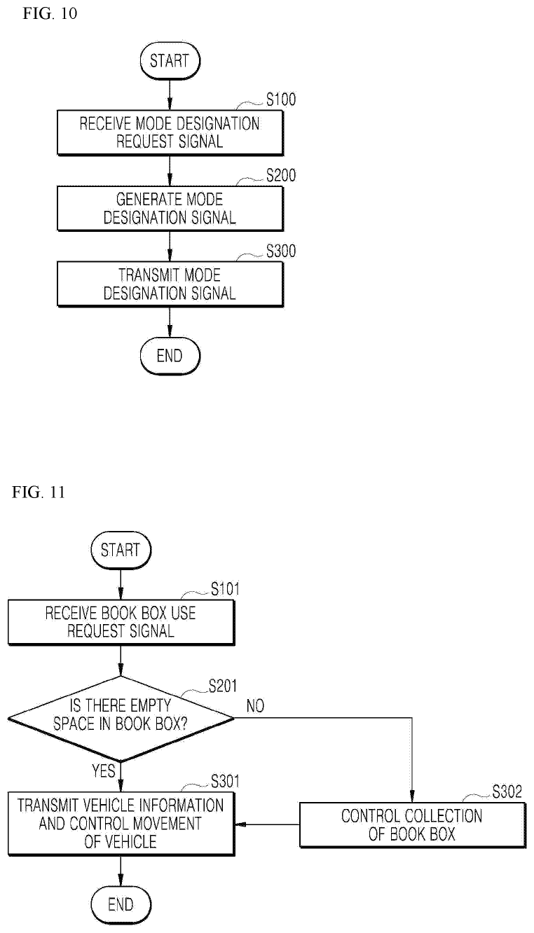

FIGS. 10 to 14 are flowcharts showing a multi-purpose autonomous vehicle control method according to an embodiment of the present disclosure.

A multi-purpose autonomous vehicle control method may include other steps in addition to the operations shown in FIGS. 10 to 14 and described below, or may not include some of the operations shown in FIGS. 10 to 14 and described below.

The server 1000 may receive a vehicle operation request signal including a designated vehicle use time and a vehicle use purpose through a user interface provided by an application of the user terminal or the vehicle user interface 2300 (operation S100).

The server 1000 may generate a mode designation signal for designating a vehicle driving mode corresponding to a vehicle use purpose when the vehicle use purpose designated by the vehicle operation request signal is an acceptable purpose at the requested vehicle use time (operation S200).

The server 1000 may control the autonomous vehicle 2000 by transmitting the generated mode designation signal to the autonomous vehicle 2000 (operation S300).

Referring to FIG. 11, a user may apply to use a book box through an application provided by a user terminal, and the user terminal may generate a book box use request signal according to the user's application, and transmit the generated book box use request signal to the server 1000.

The server 1000 may receive the book box use request signal, that is, the vehicle operation request signal including a goods delivery purpose, through the server communicator 1100 (operation S101).

When receiving the book box use request signal, the server 1000 may confirm whether there is an empty space in the book box of the autonomous vehicle 2000, that is, the receiving space for goods (operation S201). The server 1000 may confirm whether there is an empty space in the book box of a plurality of autonomous vehicles including the autonomous vehicle 2000, and store by creating a list of the autonomous vehicle having empty spaces in the book box according to the confirmed result.

When there is no empty space in the book box of the autonomous vehicle 2000, that is, the receiving space for goods, the server 1000 may control the autonomous vehicle 2000 in the autonomous mode to move it to a library, which is a destination, and to request the external server 3000, that is, the library server to collect a book in the book box (operation S302). A library librarian who is requested to collect a book through the external server 3000 may collect a book in a book box of the autonomous vehicle 2000.

The server 1000 may control the autonomous vehicle 2000 in the autonomous mode to move it to the library, which is a destination in times when there is no shuttling operation or call operation for passenger transportation.

The autonomous vehicle 2000 may control the book box to be opened only when the library librarian identification information, for example, the librarian fingerprint information included in the delivery goods information received from the server 1000 is recognized.

When there is no empty space in the book box of the autonomous vehicle 2000, the server 1000 may transmit a signal indicating that the book delivery is impossible by using the autonomous vehicle 2000 to the user terminal owned by the user who has applied the book box. At this time, the server 1000 may transmit a list of the autonomous vehicle having an empty space in the book box for the convenience of the user together with the signal indicating that the book delivery is impossible.

When there is an empty space in the book box of the autonomous vehicle 2000, or when the empty space is secured in the book box of the autonomous vehicle 2000 through the collection of the book, the server 1000 may control to transmit the location information of the autonomous vehicle 2000 to the user terminal owned by the user who has applied the book box, and to move the autonomous vehicle 2000 to the book delivery departure where the user terminal owned by the user who has applied the book box has been located (operation S301).

At this time, when the vehicle use time, at which the user who has applied the book box requests the collection, is in a shuttling operation or a call operation for passenger transportation, the server 1000 may transmit the information on the time having no shuttling operation or call operation for the convenience of the user together with the signal indicating that the book delivery is impossible.

The server 1000 may control to move the autonomous vehicle closest to the user terminal owned by the user who has applied the book box to the book delivery departure according to the list of the autonomous vehicle having empty space in the book box.

When the autonomous vehicle 2000 arrives at the book delivery departure where the user terminal owned by the user who has applied the book box has been located according to the delivery mode designation signal received from the server 1000, the user who has applied the book box may return the book in the book box.

As a book is received in a book box, the autonomous vehicle 2000 may display the delivery goods information included in the delivery mode designation signal, for example, a book name, a returnee, a return date, and a QR code for book identification on the external display, which is one module of the vehicle user interface 2300.

The server 1000 may notify the external server 3000, that is, the library server, of the return of the book, and the external server 3000 may update the information of the user who has applied the book box according to the notification of the return.

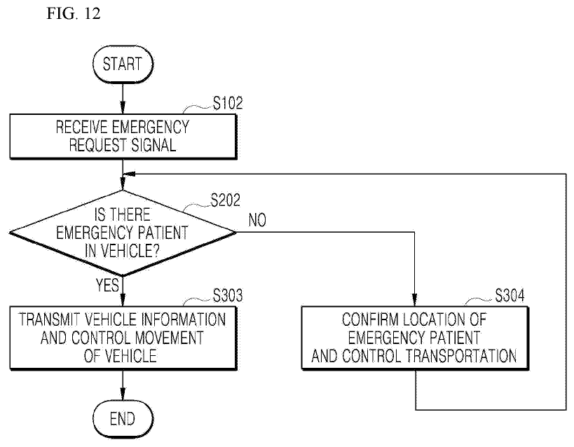

Referring to FIG. 12, the server 1000 may receive an emergency request signal, that is, a vehicle operation request signal including an emergency purpose, through the server communicator 1100 (operation S102). The autonomous vehicle 2000 may have an emergency button indicating an emergency situation as an input module of the vehicle user interface 2300.

When receiving the emergency request signal, the server 1000 may confirm whether an emergency patient is in the autonomous vehicle 2000 (operation S202). The autonomous vehicle 2000 may obtain an image including the information on whether an emergency patient is inside or outside through an internal camera of the vehicle user interface 2300 and an imaging unit of the object detector 2400 to provide it to the server 1000.

When the emergency patient is in the autonomous vehicle 2000, the server 1000 may control to move it to a hospital or a driver's boarding place, which is a destination, by transmitting the emergency mode designation signal to the autonomous vehicle 2000 to control the autonomous vehicle 2000 in the autonomous mode, and to display the emergency skin through the external display of the vehicle user interface 2300 of the autonomous vehicle 2000 (operation S303).

When the emergency patient is outside the autonomous vehicle 2000, the server 1000 may confirm the location of the emergency patient, and then control the autonomous vehicle 2000 in the autonomous mode to move it to the corresponding location, and allow the emergency patient to board in the autonomous vehicle 2000 (operation S304). The server 1000 may perform confirming whether the emergency patient is in the autonomous vehicle 2000 after the emergency patient has boarded.

The autonomous vehicle 2000 may notify the server 1000 of the boarding fact when the emergency vehicle driver boards at the driver's boarding place, and the server 1000 may switch the autonomous vehicle 2000 to the manual mode as it is notified of the boarding of the emergency vehicle driver.

The server 1000 may perform the charging operation for the emergency mode as the autonomous vehicle 2000 is switched to the manual mode.

The autonomous vehicle 2000 may notify the server 1000 of the fact that has arrived at the hospital, which is a destination, and the server 1000 may transmit a signal releasing the mode designation to the autonomous vehicle 2000 as it is notified of the fact that has arrived at the hospital, which is a destination to delete the emergency skin display through the external display of the vehicle user interface 2300.

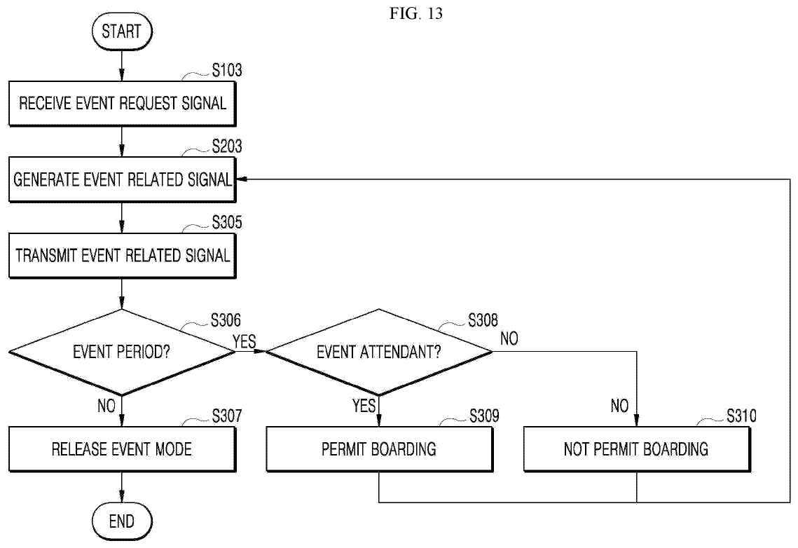

Referring to FIG. 13, the server 1000 may receive an event request signal, that is, a vehicle operation request signal including an event purpose, through the server communicator 1100 (operation S103).

When receiving the event request signal, the server 1000 may generate an event related signal, that is, an event mode designation signal (operation S203).

The server 1000 may transmit the generated event related signal to the autonomous vehicle 2000 (operation S305).

The autonomous vehicle 2000 may determine whether the event period has elapsed according to information included in the event related signal, that is, the event mode designation signal (operation S306). Here, the event period is preferably set to a time when the autonomous vehicle 2000 is not in a shuttling operation or a call operation for passenger transportation, but is not limited thereto.

When the event period has elapsed, the autonomous vehicle 2000 may release the event mode by deleting the event information being displayed if the event information is being displayed through the external display of the vehicle user interface 2300 (operation S307).

When the event period has not elapsed, the autonomous vehicle 2000 may display the event information through the external display of the vehicle user interface 2300, and determine whether the passenger is an event attendant (operation S308).

The autonomous vehicle 2000 may permit boarding when the passenger is an event attendant (operation S309), may not permit boarding when the passenger is not an event attendant (operation S310), and may request so that the server 1000 may regenerate the event mode designation signal for continuous event (operation S203).

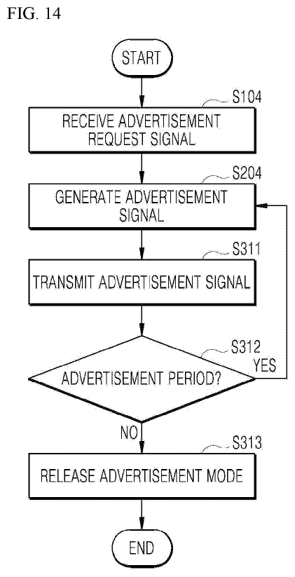

Referring to FIG. 14, the server 1000 may generate an advertisement signal, that is, an advertisement mode designation signal, when progressing a simple advertisement event having no limited attendant (operation S204), as it receives an advertisement request signal, that is, the vehicle operation request signal including an advertisement purpose through the sever communicator 1100 (operation S104).

The server 1000 may transmit the generated advertisement signal to the autonomous vehicle 2000 (operation S311).

The autonomous vehicle 2000 may determine whether the advertisement period has elapsed according to the information included in the advertisement signal, that is, the advertisement mode designation signal (operation S312). Here, the advertisement period is preferably set to a time when the autonomous vehicle 2000 is not in a shuttling operation or a call operation for passenger transportation, but is not limited thereto.

When the advertisement period has elapsed, the autonomous vehicle 2000 may release the event mode by deleting the advertisement information being displayed if the advertisement information is being displayed through the external display of the vehicle user interface 2300 (operation S313).

When the event period has not elapsed, the autonomous vehicle 2000 may display the advertisement information through the external display of the vehicle user interface 2300, and request the server 1000 to regenerate the advertisement signal, that is, the advertisement mode designation signal for continuous advertisement (operation S204).

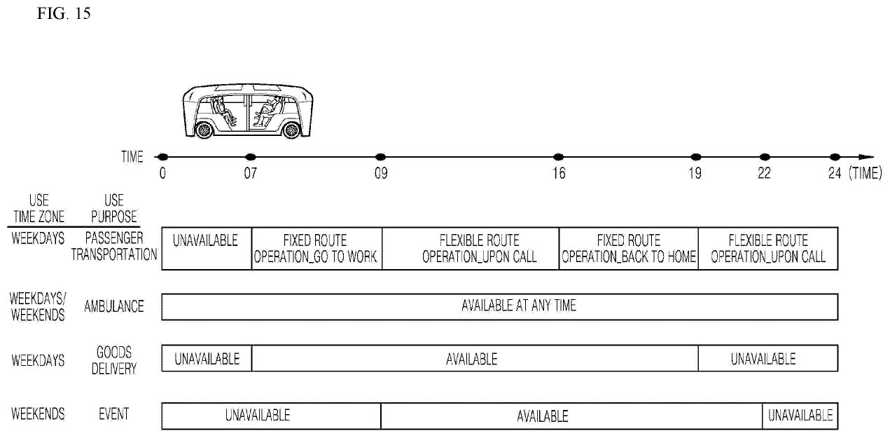

FIG. 15 is a diagram showing a scheduling operation of the multi-purpose autonomous vehicle control apparatus installed at a vehicle side according to an embodiment of the present disclosure.

When the emergency purpose occurs, the autonomous vehicle 2000 may operate in the emergency mode with the highest priority, and when there is no emergency patient, the autonomous vehicle 2000 may operate in the passenger transportation purpose, the goods delivery mode, or the event mode.

For example, in the case of a weekday, when used for the use purpose of the passenger transportation, the autonomous vehicle 2000 may operate a fixed route by using all stops set in the commute time zone under the control of the server 1000, and at other times, operate in the goods delivery mode or the event mode by reflecting the passenger demand information and the driving area information. That is, the server 1000 may set a first priority as an emergency mode, a second priority as a passenger transportation purpose, a third priority as a goods delivery mode, and a fourth priority as an event mode.

In addition, the server 1000 may limit the time available for the autonomous vehicle 2000 in the passenger transportation purpose or the goods delivery mode to weekdays, and limit the time available in the event mode to weekends or holidays.

The present disclosure described above may be implemented as a computer readable code in a medium in which a program has been recorded. The computer readable medium includes all types of recording devices in which data readable by a computer system readable may be stored. Examples of the computer readable medium include a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like, and it may also be implemented in the form of a carrier wave (for example, transmission over the Internet). In addition, the computer may include a processor or a controller. Therefore, the above description should not be construed as limiting and should be considered illustrative. The scope of the present disclosure should be determined by rational interpretation of the appended claims, and all changes within the scope of equivalents of the present disclosure are included in the scope of the present disclosure.

What is claimed is:

1. A multi-purpose autonomous vehicle control apparatus for controlling an autonomous vehicle having a receiving space and an external display and for providing a shuttling operation for driving along a predetermined route, comprising:
a communicator for receiving a vehicle operation request signal comprising a vehicle use time and a vehicle use purpose; and
a controller for generating a mode designation signal for designating a vehicle operation mode corresponding to the vehicle use purpose, when the vehicle use purpose is a purpose allowable in the vehicle use time,
wherein the communicator transmits the mode designation signal to the autonomous vehicle, and
wherein the vehicle operation mode comprises at least two modes.

2. The multi-purpose autonomous vehicle control apparatus of claim 1,
wherein the controller generates the mode designation signal when the vehicle use purpose is an emergency purpose for emergency patient transportation, and generates the mode designation signal except when the vehicle use time is a passenger transportation time, when the vehicle use purpose is not an emergency purpose, and
wherein the passenger transportation time is a time when the autonomous vehicle is in a shuttling operation or a call operation for passenger transportation.

3. The multi-purpose autonomous vehicle control apparatus of claim 1,
wherein the mode designation signal comprises an emergency mode designation signal for designating a vehicle operation mode corresponding to an emergency purpose, a delivery mode designation signal for designating the vehicle operation mode corresponding to a goods delivery purpose, and an event mode designation signal for designating the vehicle operation mode corresponding to an event purpose.

4. The multi-purpose autonomous vehicle control apparatus of claim 3,
wherein the emergency mode designation signal comprises emergency skin data for displaying an emergency vehicle skin on the external display and a control signal for moving the autonomous vehicle to a hospital as an emergency patient is received in the receiving space.

5. The multi-purpose autonomous vehicle control apparatus of claim 3,
wherein the delivery mode designation signal comprises a control signal for moving the autonomous vehicle to a departure area and a destination and delivery information data for displaying delivery goods information on the external display as the delivery goods are received in the receiving space.

6. The multi-purpose autonomous vehicle control apparatus of claim 3,
wherein the controller generates the delivery mode designation signal as an empty space in which goods are received is present in the receiving space.

7. The multi-purpose autonomous vehicle control apparatus of claim 3,
wherein the event mode designation signal comprises a control signal for receiving a passenger in the receiving space when satisfying a predetermined condition and event information data for displaying event information on the external display.

8. The multi-purpose autonomous vehicle control apparatus of claim 1,
wherein the communicator transmits the mode designation signal on the basis of the uplink grant of a 5G network connected to operate the autonomous vehicle in an autonomous mode.

9. A multi-purpose autonomous vehicle control method for controlling an autonomous vehicle having a receiving space and an external display and for providing a shuttling operation for driving along a predetermined route, comprising:
receiving a vehicle operation request signal comprising a vehicle use time and a vehicle use purpose;
generating a mode designation signal for designating a vehicle operation mode corresponding to the vehicle use purpose, when the vehicle use purpose is a purpose allowable in the vehicle use time; and
transmitting the mode designation signal to the autonomous vehicle,
wherein the vehicle operation mode comprises at least two modes.

10. The multi-purpose autonomous vehicle control method of claim 9,
wherein generating the mode designation signal comprises:
generating the mode designation signal, when the vehicle use purpose is an emergency purpose for an emergency patient transportation; and
generating the mode designation signal except when the vehicle use time is a passenger transportation time, when the vehicle use purpose is not an emergency purpose, and
wherein the passenger transportation time is a time when the autonomous vehicle is in a shuttling operation or a call operation for passenger transportation.

11. The multi-purpose autonomous vehicle control method of claim 9,
wherein the mode designation signal comprises an emergency mode designation signal for designating a vehicle operation mode corresponding to an emergency purpose, a delivery mode designation signal for designating the vehicle operation mode corresponding to a goods delivery purpose, and an event mode designation signal for designating the vehicle operation mode corresponding to an event purpose.

12. The multi-purpose autonomous vehicle control method of claim 11,
wherein the emergency mode designation signal comprises emergency skin data for displaying an emergency vehicle skin on the external display and a control signal for moving the autonomous vehicle to a hospital as an emergency patient is received in the receiving space.

13. The multi-purpose autonomous vehicle control method of claim 11,
wherein the delivery mode designation signal comprises a control signal for moving the autonomous vehicle to a departure area and a destination and delivery information data for displaying delivery goods information on the external display as the delivery goods are received in the receiving space.

14. The multi-purpose autonomous vehicle control method of claim 11,
wherein generating the mode designation signal comprises:
generating the delivery mode designation signal as an empty space in which goods are received is present in the receiving space.

15. The multi-purpose autonomous vehicle control method of claim 11,
wherein the event mode designation signal comprises a control signal for receiving a passenger in the receiving space when satisfying a predetermined condition and event information data for displaying event information on the external display.

16. The multi-purpose autonomous vehicle control method of claim 9, further comprising transmitting the mode designation signal on the basis of the uplink grant of a 5G network connected to operate the autonomous vehicle in an autonomous mode.

17. A computer readable recording medium recording a program, comprising:
as the computer readable recording medium recording a multi-purpose autonomous vehicle control program for controlling an autonomous vehicle having a receiving space and an external display, and for providing a shuttling operation for driving along a predetermined route,
a means for receiving a vehicle operation request signal comprising a vehicle use time and a vehicle use purpose;
a means for generating a mode designation signal for designating a vehicle operation mode corresponding to the vehicle use purpose, when the vehicle use purpose is a purpose allowable in the vehicle use time; and
a means for transmitting the mode designation signal to the autonomous vehicle,
wherein the vehicle operation mode comprises at least two modes.
